(19) United States
(12) Patent Application Publication
(10) Pub. No.: US 2019/0225218 A1
(43) Pub. Date: Jul. 25, 2019

(54) VEHICLE CONTROL APPARATUS

(71) Applicant: Honda Motor Co., Ltd., Tokyo (JP)

(72) Inventors: Hisashi Ishikawa, Wako-shi (JP); Masayuki Sadakiyo, Wako-shi (JP); Tomoyuki Noguchi, Wako-shi (JP); Takashi Adachi, Wako-shi (JP)

(21) Appl. No.: 16/251,929

(22) Filed: Jan. 18, 2019

(30) Foreign Application Priority Data
Jan. 24, 2018 (JP) 2018-009757

(51) Int. Cl. B60W 30/14; B60W 40/06

(52) U.S. Cl. CPC B60W 30/146; B60W 40/06

(57) ABSTRACT

A vehicle control apparatus including an electric control unit having a microprocessor and a memory. The microprocessor is configured to perform detecting that a first wheel of one of a front and rear wheels has ridden over a level difference; calculating a target vehicle speed required for a riding over of a second wheel of the other of the front and rear wheels when it is detected that the first wheel has ridden over the level difference, and controlling the actuator so that a vehicle speed immediately before the second wheel rides over the level difference after the first wheel has ridden over the level difference becomes the target vehicle speed.

### CROSS-REFERENCE TO RELATED APPLICATION

This application is based upon and claims the benefit of priority from Japanese Patent Application No. 2018-009757 filed on Jan. 24, 2018, the content of which is incorporated herein by reference.

### BACKGROUND OF THE INVENTION

### Field of the Invention

This invention relates to a vehicle control apparatus configured to control a vehicle with a self-drive function.

### Description of the Related Art

Conventionally, apparatuses adapted to control vehicle travel behavior when the vehicle rides over a sudden difference (change) in road level are known. For example, in an apparatus of this type described in Japanese Unexamined Patent Publication No. 2013-103593 (JP2013-103593A), after rear wheels of an FF-layout hybrid vehicle running in reverse ride over a level difference and just before the front wheels contact the level difference, traveling force is increased by motoring the engine with a motor-generator, thereby helping the front wheels to ride over the level difference more easily.

However, the apparatus described in JP2013-103593A is applicable only to vehicles capable of engine motoring using a motor-generator during vehicle traveling and cannot be widely applied to many types of vehicles.

### SUMMARY OF THE INVENTION

An aspect of the present invention is a vehicle control apparatus configured to control an actuator for driving a vehicle so that, after a first wheel of one of a front wheel and a rear wheel rides over a level difference between a first road surface and a second road surface higher than the first road surface, a second wheel of the other of the front wheel and the rear wheel rides over the level difference. The vehicle control apparatus includes an electric control unit having a microprocessor and a memory connected to the microprocessor. The microprocessor is configured to perform: detecting that the first wheel has ridden over the level difference; calculating a target vehicle speed required for a riding over of the second wheel when it is detected that the first wheel has ridden over the level difference; and controlling the actuator so that a vehicle speed immediately before the second wheel rides over the level difference after the first wheel has ridden over the level difference becomes the target vehicle speed.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle to which a vehicle control apparatus according to an embodiment of the present invention is applied;

FIG. 2 is a block diagram schematically illustrating overall configuration of the vehicle control apparatus according to an embodiment of the present invention;

FIG. 3 is a diagram showing an example of a traveling behavior of a vehicle to which the vehicle control apparatus according to an embodiment of the present invention is applied;

FIG. 4 is a side view of a vehicle showing an example of operation of FIG. 3;

FIG. 5 is a block diagram illustrating main configuration of the vehicle control apparatus according to the embodiment of the present invention;

FIG. 6 is a side view of the vehicle showing an example of operation following FIG. 4; and

FIG. 7 is a flow chart showing an example of processing performed in a controller of FIG. 5.

### DETAILED DESCRIPTION OF THE INVENTION

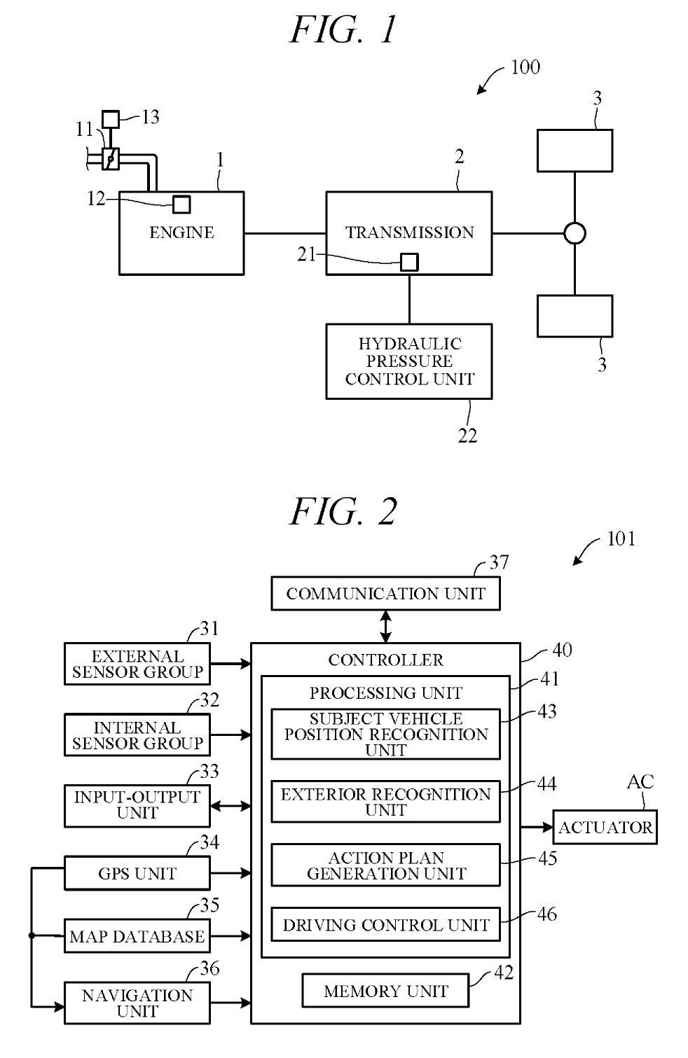

Hereinafter, an embodiment of the present invention is explained with reference to FIGS. 1 to 7. A vehicle control apparatus according to an embodiment of the present invention is applied to a vehicle (self-driving vehicle) having a self-driving capability. First, configurations of the self-driving vehicle are explained. FIG. 1 is a diagram showing a configuration overview of a driving system of a self-driving vehicle 100 incorporating a vehicle control apparatus according to the present embodiment. The vehicle 100 is not limited to driving in a self-drive mode requiring no driver driving operations but is also capable of driving in a manual drive mode by driver operations.

As shown in FIG. 1, the vehicle 100 includes an engine 1 and a transmission 2 placed in an engine room at front of the vehicle 100. The vehicle 100 includes a front wheels as drive wheels and rear wheels as driven wheels, and is an FF-layout vehicle (front engine and front drive). Therefore, front weight applied to the front wheels is heavier than rear weight applied to the rear wheels.

The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Air intake volume is metered by the throttle valve. An opening angle of the throttle valve 11 (throttle opening angle) is changed by a throttle actuator 13 operated by an electric signal. The opening angle of the throttle valve 11 and an amount of fuel injected from the injector 12 (injection timing and injection time) are controlled by a controller 40 (FIG. 2).

The transmission 2, which is installed in a power transmission path between the engine 1 and drive wheels 3, varies speed ratio of rotation of from the engine 1, and converts and outputs torque from the engine 1. The rotation of speed converted by the transmission 2 is transmitted to the drive wheels 3, thereby the vehicle 100 travels. Optionally, the vehicle 100 can be configured as an electric vehicle or hybrid vehicle by providing a drive motor as a drive power source in place of or in addition to the engine 1.

The transmission 2 is, for example, a stepped transmission enabling stepwise speed ratio (gear ratio) shifting in accordance with multiple speed stages. Optionally, a continuously variable transmission enabling stepless speed ratio shifting can be used as the transmission 2. Although omitted in the drawings, power from the engine 1 can be input to the transmission 2 through a torque converter. The transmission 2 can, for example, incorporate a dog clutch, friction clutch or other engaging element 21. A hydraulic pressure control unit 22 can shift speed stage of the transmission 2 by controlling flow of oil to the engaging element 21.

FIG. 2 is a block diagram schematically illustrating overall configuration of a vehicle control system 101 for controlling the self-driving vehicle 100 of FIG. 1. As shown in FIG. 2, the vehicle control system 101 includes mainly of the controller 40, and as members communicably connected with the controller 40 through CAN (Controller Area Network) communication or the like, an external sensor group 31, an internal sensor group 32, an input-output unit 33, a GPS unit 34, a map database 35, a navigation unit 36, a communication unit 37, and actuators AC for making the vehicle travel.

The term external sensor group 31 herein is a collective designation encompassing multiple sensors (external sensors) for detecting external circumstances constituting ambience data of the vehicle 100. For example, the external sensor group 31 includes, inter alia, a LIDAR (Light Detection and Ranging) for measuring distance from the vehicle 100 to ambient obstacles by measuring scattered light produced by laser light radiated from the vehicle 100 in every direction, a RADAR (Radio Detection and Ranging) for detecting other vehicles and obstacles around the vehicle 100 by radiating electromagnetic waves and detecting reflected waves, and a CCD, CMOS or other image sensor-equipped on-board cameras mounted on the vehicle 100 for imaging ambience of the vehicle 100 (forward, reward and sideways).

The term internal sensor group 32 herein is a collective designation encompassing multiple sensors (internal sensors) for detecting driving state of the vehicle 100. For example, the internal sensor group 32 includes, inter alia, a vehicle speed sensor for detecting vehicle speed of the vehicle 100, acceleration sensors for detecting forward-rearward direction acceleration and left-right direction acceleration (lateral acceleration) of the vehicle 100, respectively, an engine speed sensor for detecting rotational speed of the engine 1, a yaw rate sensor for detecting rotation angle speed around a vertical axis through center of gravity of the vehicle 100, and a throttle opening sensor for detecting opening angle of the throttle valve 11 (throttle opening angle). The internal sensor group 32 also includes sensors for detecting driver driving operations in manual drive mode, including, for example, accelerator pedal operations, brake pedal operations, steering wheel operations and the like.

The term input-output unit 33 is used herein as a collective designation encompassing apparatuses receiving instructions input by the driver and outputting information to the driver. For example, the input-output unit 33 includes, inter alia, switches which the driver uses to input various instructions, a microphone which the driver uses to input voice instructions, a display for presenting information to the driver via displayed images, and a speaker for presenting information to the driver by voice. A self/manual drive select switch for instructing either self-drive mode or manual drive mode is included in various switches constituting the input-output unit 33.

The self/manual drive select switch, for example, is configured as a switch manually operable by the driver to output instructions of switching to the self-drive mode enabling self-drive functions or the manual drive mode disabling self-drive functions in accordance with switch operation. Optionally, the self/manual drive select switch can be configured to instruct switching from manual drive mode to self-drive mode or from self-drive mode to manual drive mode when a predetermined condition is satisfied without operating the self/manual drive select switch. In other words, drive mode can be switched automatically not manually in response to automatic switching of the self/manual drive select switch.

The GPS unit 34 includes a GPS receiver for receiving position determination signals from multiple GPS satellites, and measures absolute position (latitude, longitude and the like) of the vehicle 100 based on the signals received from the GPS receiver.

The map database 35 is a unit storing general map data used by the navigation unit 36 and is, for example, implemented using a hard disk. The map data include road position data and road shape (curvature etc.) data, along with intersection and road branch position data. The map data stored in the map database 35 are different from high-accuracy map data stored in a memory unit 42 of the controller 40.

The navigation unit 36 retrieves target road routes to destinations input by the driver and performs guidance along selected target routes. Destination input and target route guidance is performed through the input-output unit 33. Target routes are computed based on subject vehicle current position measured by the GPS unit 34 and map data stored in the map database 35.

The communication unit 37 communicates through networks including the Internet and other wireless communication networks to access servers (not shown in the drawings) to acquire map data, traffic data and the like, periodically or at arbitrary times. Acquired map data are output to the map database 35 and/or memory unit 42 to update their stored map data. Acquired traffic data include congestion data and traffic light data including, for instance, time to change from red light to green light.

The actuators AC are provided to perform driving of the vehicle 100. The actuators AC include a throttle actuator 13 for adjusting opening angle of the throttle valve of the engine 1 (throttle opening angle), a shift actuator for changing speed stage of the transmission 2 by controlling oil flow to engaging element 21 of the transmission 2, a brake actuator for operating a braking device, and a steering actuator for driving a steering unit.

The controller 40 is constituted by an electronic control unit (ECU). In FIG. 2, the controller 40 is integrally configured by consolidating multiple function-differentiated ECUs such as an engine control ECU, a transmission control ECU, a clutch control ECU and so on. Optionally, these ECUs can be individually provided. The controller 40 incorporates a computer including a CPU or other processing unit (a microprocessor) 41, the memory unit (a memory) 42 of RAM, ROM, hard disk and the like, and other peripheral circuits not shown in the drawings.

The memory unit 42 stores high-accuracy detailed map data including, inter alia, lane center position data and lane boundary line data. More specifically, road data, traffic regulation data, address data, facility data, telephone number data, parking data and the like are stored as map data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 42 also stores a shift map (shift chart) serving as a shift operation reference, various programs for performing processing, and threshold values used in the programs, etc.

As functional configurations, the processing unit 41 includes a subject vehicle position recognition unit 43, an exterior recognition unit 44, an action plan generation unit 45, and a driving control unit 46.

The subject vehicle position recognition unit 43 recognizes map position of the vehicle 100 (subject vehicle position) based on position data of the vehicle 100 calculated by the GPS unit 34 and map data stored in the map database 35. Optionally, the subject vehicle position can be recognized using map data (building shape data and the like) stored in the memory unit 42 and ambience data of the vehicle 100 detected by the external sensor group 31, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 37.

The exterior recognition unit 44 recognizes external circumstances around the vehicle 100 based on signals from cameras, LIDERs, RADARs and the like of the external sensor group 31. For example, it recognizes position, speed and acceleration of nearby vehicles (forward vehicle or rearward vehicle) driving in the vicinity of the subject vehicle, position of vehicles stopped or parked in the vicinity of the subject vehicle, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 45 generates a driving path of the vehicle 100 (target path) from present time point to a certain time ahead based on, for example, a target route computed by the navigation unit 36, subject vehicle position recognized by the subject vehicle position recognition unit 43, and external circumstances recognized by the exterior recognition unit 44. When multiple paths are available on the target route as target path candidates, the action plan generation unit 45 selects from among them the path that optimally satisfies legal compliance, safe efficient driving and other criteria, and defines the selected path as the target path. The action plan generation unit 45 then generates an action plan matched to the generated target path. An action plan is also called “travel plan”.

The action plan includes action plan data set for every unit time Δt (e.g., 0.1 sec) between present time point and a predetermined time period T (e.g., 5 sec) ahead, i.e., includes action plan data set in association with every unit time Δt interval. The action plan data include position data of the vehicle 100 and vehicle state data for every unit time Δt. The position data are, for example, target point data indicating 2D coordinate position on road, and the vehicle state data are vehicle speed data indicating vehicle speed, direction data indicating direction of the vehicle 100, and the like.

The action plan generation unit 45 generates target path by connecting position data every unit time Δt interval between present time point and the predetermined time period T ahead in time order. At this time, the action plan generation unit 45 calculates acceleration (target acceleration) of sequential unit times Δt based on vehicle speed (target vehicle speed) at target points of sequential unit times Δt on target path. In other words, the action plan generation unit calculates target vehicle speed and target acceleration. Optionally, the driving control unit 46 can calculate target acceleration.

In self-drive mode, the driving control unit 46 controls the actuators AC to drive the vehicle 100 at target vehicle speed and target acceleration along target path generated by the action plan generation unit 45. For example, the driving control unit 46 controls the throttle actuator 13, shift actuator, brake actuator, and steering actuator so as to drive the vehicle 100 through target points of the unit times Δt.

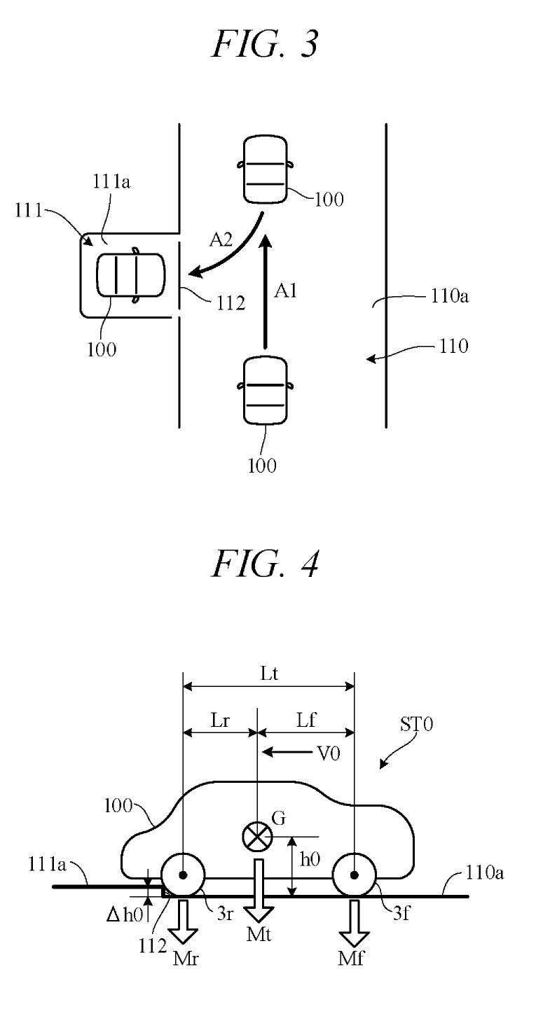

A vehicle control apparatus according to the present invention is explained next. FIG. 3 is a plan view showing an example of traveling behavior of a vehicle 100 incorporating the vehicle control apparatus according to the present embodiment. FIG. 3 shows an example in which the vehicle 100, initially running on a road 110, parks perpendicular to the road lane in an off-road parking space 111 facing the road 110. This example relates to a case in which the parking space 111 is designated as destination of the self-driving vehicle 100 and shows how the vehicle 100 moves into the parking space 111 by autonomous driving upon reaching the destination. As shown, the vehicle 100 once passes beyond the parking space 111 as indicated by arrow A1, and then after an onboard camera or the like recognizes the position of the parking space 111, the vehicle 100 backs into the parking space 111 as indicated by arrow A2.

At an entrance of the parking space 111 is formed a vertical or nearly vertical curb-like rise (level difference) 112 rising upward from surface 110a (called “reference surface”) of the road 110, and surface 111a of the parking space 111 is at a higher level than the reference surface 110a. FIG. 4 is a side view showing the vehicle 100 immediately before entering the parking space 111. In the state shown in FIG. 4, rear wheels 3r of the vehicle 100 running in reverse at vehicle speed V0 are in contact with the rise 112 (rise pre-ride-over state ST0). The surface 111a of the parking space 111 is, for example, formed as a flat horizontal surface.

Center of gravity G of the vehicle 100 is located between the front wheels 3f and the rear wheels 3r. Defining font axle vehicle weight as Mf, rear axle vehicle weight as Mr, total vehicle weight (Mf+Mr) as Mt and wheel base as Lt, distance Lf between center of gravity G and the front wheels 3f is Lt·Mr/Mt, and distance Lr between center of gravity G and the rear wheels 3r is Lt·Mf/Mt. When the vehicle 100 is located on the road 110, height from reference surface 110a to center of gravity G is h0. Values of vehicle weights Mf, Mr and Mt, wheelbase Lt, center of gravity G, distances Lf and Lr between center of gravity G and front and rear wheels, and center of gravity height h0 are vehicle-specific values stored in the memory unit 42 in advance. Vehicle weights Mt, Mf and Mr and center of gravity position vary with passenger body weight and riding position, and depending on whether any baggage onboard. Therefore, in order to accurately ascertain vehicle weights Mt, Mf and Mr and center of gravity position, load sensors can be optionally installed on front wheel 3f side and rear wheel 3r side to successively detect font axle vehicle weight and rear axle vehicle weight.

In order for the vehicle 100 to move into the parking space 111, the rear wheels 3r and front wheels 3f must sequentially ride over the rise 112. Height of a rise 112 that the wheels 3f and 3r can ride over is a height Δh lower than radius of the wheels 3f and 3r and one at which a corner of the rise 112 does not hit bumpers or uncovers of the vehicle 100. Since the vehicle 100 in the present embodiment is an FF-layout vehicle, ride-over of the rise 112 is more difficult for the front wheels 3f operating as drive wheels than for the rear wheels 3r operating as driven wheels. So in the present embodiment, the vehicle control apparatus is configured as described hereinafter in order to facilitate ride-over of the rise 112 by the front wheels 3f following ride-over of the rise 112 by the rear wheels 3r.

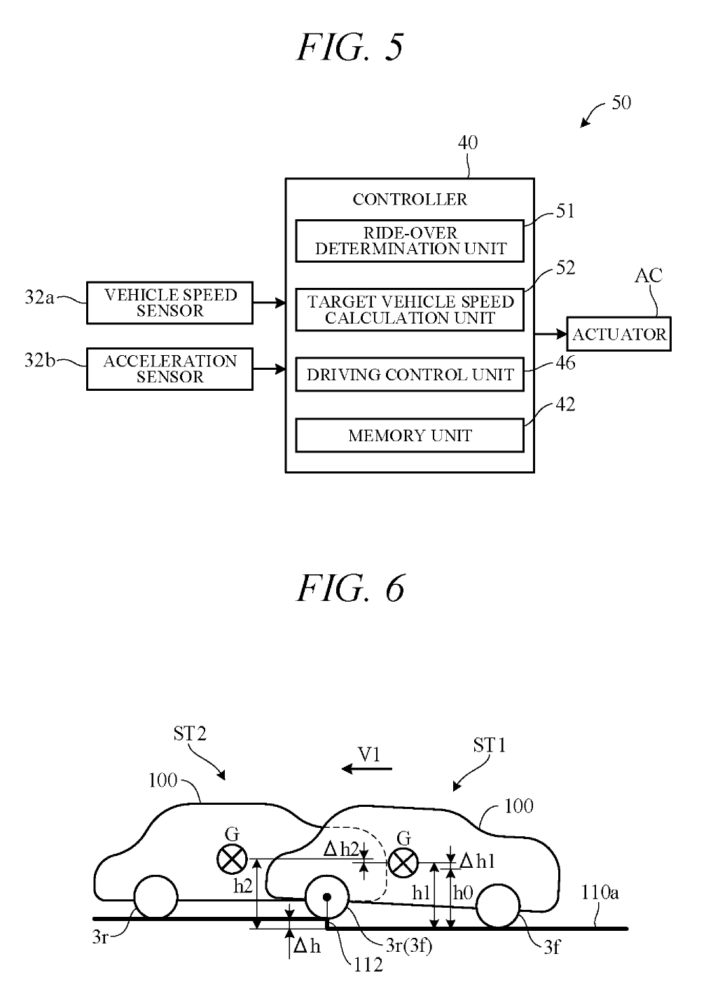

FIG. 5 is a block diagram showing main elements of a vehicle control apparatus 50 according to the present embodiment. The vehicle control apparatus 50 is an apparatus for parking the vehicle 100 in the parking space 111 by autonomous driving and is part of the vehicle control system 101 of FIG. 2. As shown in FIG. 5, the vehicle control apparatus 50 includes the controller 40, and a vehicle speed sensor 32a, an acceleration sensor 32b and actuators AC connected to the controller 40.

The vehicle speed sensor 32a detects speed of the vehicle 100, and the acceleration sensor 32b detects acceleration (e.g., forward, reverse and vertical acceleration) of the vehicle 100. The vehicle speed sensor 32a and acceleration sensor 32b are members of the internal sensor group 32 of FIG. 2. The acceleration sensor 32b is used to detect whether or not the rear wheels 3r have ridden over the rise 112. Alternatively, in order to increase accuracy of rise ride-over detection, a six-axis sensor combining a three-axis acceleration sensor and a three-axis gyro sensor can be used in place of the acceleration sensor 32b.

As functional constituents, the controller 40 includes a ride-over determination unit 51, a target vehicle speed calculation unit 52, the driving control unit 46, and the memory unit 42. The ride-over determination unit 51 and target vehicle speed calculation unit 52 are, for example, part of the action plan generation unit 45 of FIG. 2.

The ride-over determination unit 51 determines based on signals from the vehicle speed sensor 32a and acceleration sensor 32b whether the rear wheels 3r (driven wheels) have ridden over the rise 112. For example, when the rear wheels 3r hit the rise 112, the resulting increases in running resistance lowers vehicle speed and reduces acceleration of the vehicle 100. When as a result the ride-over determination unit 51 detects that the rear wheels 3r hit the rise 112, and thereafter detects change in vehicle speed and acceleration owing to decreased running resistance (e.g., vehicle speed and acceleration increase), it determines that the rear wheels 3r have ridden over the rise 112. Optionally, whether the rear wheels 3r have ridden over the rise 112 can be determined by using the acceleration sensor 32b to detect vertical movement of the vehicle 100 when riding over the rise.

FIG. 6 is a diagram showing state of the vehicle 100 immediately after the rear wheels 3r ride over the rise 112 (rear-wheel ride-over state ST1) and state of the vehicle 100 immediately after the front wheels 3f ride over the rise 112 following the rear wheels 3r (front-wheel ride-over state ST2). By saying that the rear wheels 3r or front wheels 3f ride over the rise 112 is meant a condition in which, as shown in FIG. 6, center of the rear wheels 3r or front wheels 3f assumes a position on a vertical line rising from the corner of the rise 112.

In rear-wheel ride-over state ST1, position of the rear wheels 3r is higher than position of the front wheels 3f and the vehicle 100 therefore inclines forward. So when the ride-over determination unit 51 determines that the rear wheels 3r hit the rise 112, and thereafter detects forward inclined posture of the vehicle 100 by means of, for example, the acceleration sensor 32b or an unshown tilt sensor, it determines that the rear wheels 3r have ridden over the rise 112 (rear-wheel ride-over state ST1).

In rear-wheel ride-over state ST1, height h1 of center of gravity G from reference surface 110a is greater by Δh1 than height h0 of center of gravity G in rise pre-ride-over state ST0 (FIG. 4). Moreover, in front-wheel ride-over state ST2, height h2 of center of gravity G from reference surface 110a is greater by Δh2 than height h1 of center of gravity G in rear-wheel ride-over state ST1. Sum of center of gravity G changes Δh1+Δh2 is equal to height Δh of the rise 112.

After the rear wheels 3r ride over the rise 112, the target vehicle speed calculation unit 52 calculates target vehicle speed Va of the vehicle 100 immediately before the front wheels 3f ride over the rise 112, more exactly just before the front wheels 3f hit the rise 112. This target vehicle speed Va is vehicle speed for obtaining inertial force of the vehicle 100 needed for the front wheels 3f to ride over the rise 112. Arithmetic expression of target vehicle speed Va is derived as set out below.

First assume that mechanical energy is stored between rise pre-ride-over state ST0 and rear-wheel ride-over state ST1. In this case, the following Expression (I) holds:

1/2·Mt·V1²+Mt·g·Δh1=1/2·Mt·V0² (I),

where Mt is vehicle weight, V0 is vehicle speed in rise pre-ride-over state (FIG. 4), V1 is vehicle speed in rear-wheel ride-over state ST1 (FIG. 6), Δh1 is height change of center of gravity G between rise pre-ride-over state ST0 and rear-wheel ride-over state ST1, and g is gravitational acceleration.

Rearranging Expression (I) gives center of gravity height change Δh1:

Δh1=1/2·1/g·(V0²−V1²) (II).

Based on proportional relationship between center of gravity G and wheelbase Lt (FIG. 4), i.e., Lf=Lt·Mr/Mt and Lr=Lt·Mf/Mt, height Δh of rise 112 is given by:

Δh=Δh1·Mt/Mr (III),

where Δh1 is change of center of gravity height.

The front wheels 3f can ride over the rise 112 following the rear wheels 3r on condition that change of center of gravity G height between rise pre-ride-over state ST0 and front-wheel ride-over state ST2 is height Δh of the rise 112. Change Δh2 of center of gravity G height between rear-wheel ride-over state ST1 and front-wheel ride-over state ST2 (FIG. 6) is obtained based on Expression (III) as:

Δh2=Δh−Δh1=Δh1·Mf/Mr (IV).

In order for the front wheels 3f to ride over the rise 112, kinetic energy of the vehicle 100 needs to be greater than potential energy corresponding to change Δh2 of center of gravity G height. This requires the following inequality to be satisfied:

1/2·Mt·Va²−Mt·g·Δh2>0 (V).

Substituting Δh2 of Expression (IV) into Expression (V), gives the following rearranged Expression (VI):

Va>√((V0²−V1²)·Mf/Mr) (VI).

In light of the foregoing, the target vehicle speed calculation unit 52 uses vehicle speed V0 of rise pre-ride-over state ST0, vehicle speed V1 of rear-wheel ride-over state ST1 and ratio Mf/Mr of front axle vehicle weight Mf relative to rear axle vehicle weight Mr to calculate target vehicle speed Va satisfying Expression (VI). More specifically, the target vehicle speed calculation unit 52 responds to detection of rear wheel 3r ride-over by calculating right side of Expression (VI) using current vehicle speed V1, vehicle speed V0 detected earlier and stored in the memory unit 42, and weight ratio Mf/Mr of front wheel 3f and rear wheel 3r axle vehicle weights stored in the memory unit 42. It then defines a value greater than the calculated value as target vehicle speed Va.

Although target vehicle speed Va needs to be greater than right side of Expression (VI), setting target vehicle speed Va too high results in occurrence of strong shock when the drive wheels (front wheels 30 ride over the rise 112 and may lead to sudden braking of the vehicle 100 becoming necessary in order to avoid hitting an obstacle behind the vehicle 100. On the other hand, if target vehicle speed Va should be set to a value only slightly greater than value of right side of Expression (VI), the front wheels 3f might not be able to ride over the rise 112 owing to deficient inertial force. Taking these risks into consideration, target vehicle speed Va is defined, for example, by adding an appropriate predetermined value to the value of right side of Expression (VI).

After the rear wheels 3r ride over the rise 112, the driving control unit 46 controls actuators AC so as to control vehicle speed from V1 to target vehicle speed Va while the vehicle 100 runs length of wheelbase Lt. More specifically, acceleration enabling vehicle speed to increase from V1 to Va while the vehicle 100 runs predetermined distance Lt is set as desired acceleration and the driving control unit 46 controls actuators AC (e.g. throttle actuator, shift actuator etc.) so as to control running acceleration to this desired acceleration. As a result, the front wheels 3f (drive wheels) can easily ride over the rise 112 mainly by inertial force.

After vehicle speed is controlled to target vehicle speed Va up to immediately before the front wheels 3f ride over the rise 112, the driving control unit 46 lowers vehicle propulsion torque to a predetermined value (e.g., 0). The reason for this is that in the present embodiment the front wheels 3f ride over the rise 112 mainly by inertial force, so that no need arises to increase vehicle propulsion torque between just before and just after riding over the rise 112.

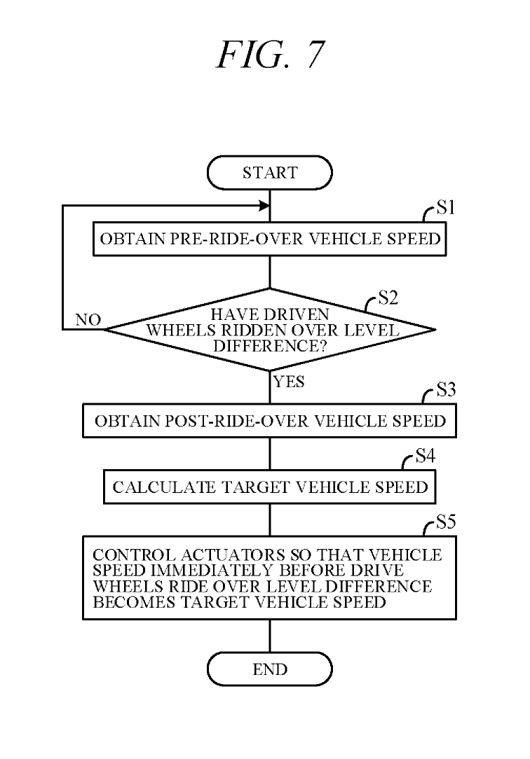

FIG. 7 is a flowchart showing an example of processing performed by the controller 40 (CPU) of FIG. 4 in accordance with a program stored in the memory unit 42 in advance. The processing shown in this flowchart is started, for example, when movement of the vehicle 100 into the parking space 111 as shown in FIG. 3 is instructed.

First, in S1 (S: processing Step), vehicle speed detected by the vehicle speed sensor 32a is read and stored in the memory unit 42 as pre-ride-over vehicle speed V0 before the rear wheels 3r (driven wheels) ride over the rise 112. Next, in S2, processing is performed by the ride-over determination unit 51 to determine based on signals from the vehicle speed sensor 32a and the acceleration sensor 32b whether the driven wheels have ridden over the rise 112. If a positive decision is made in S2, the routine proceeds to S3, and if a negative decision is made, returns to S1, Pre-ride-over vehicle speed V0 is updated every time the processing of S1 is performed. Vehicle speed V0 at time of final update is therefore vehicle speed immediately before the rear wheels 3r ride over the rise 112.

In S3, vehicle speed detected by the vehicle speed sensor 32a, i.e., post-ride-over vehicle speed V1 immediately after the rear wheels 3r ride over the rise 112, is read. Next, in S4, processing is performed by the target vehicle speed calculation unit 52 to calculate target vehicle speed Va satisfying Expression (VI) using vehicle speed V0 acquired in S1, vehicle speed V1 acquired in S3, and relationship between front wheel axle vehicle weight Mf and rear wheel axle vehicle weight Mr stored in the memory unit 42 in advance. Next, in S5, processing is performed by the driving control unit 46 to control actuators AC so as to control actual vehicle speed immediately before the front wheels 3f (drive wheel) ride over the rise 112 to target vehicle speed Va.

Main operation of the vehicle control apparatus 50 according to the present embodiment is more concretely explained in the following. Upon reaching the self-driving vehicle 100 destination set to, for example, the parking space 111 having the curb-like entrance rise 112, the vehicle 100 backs into the parking space 111 as shown in FIG. 3. At this time the controller 40 determines whether or not the rear wheels 3r are to ride over the rise 112 and calculates target vehicle speed Va based on vehicle speed V0 immediately before the rear wheels 3r ride over the rise 112, vehicle speed V1 immediately after the rear wheels 3r ride over the rise 112, and ratio Mf/Mr of front wheel axle weight Mf relative to rear wheel axle weight Mr (S4).

After the rear wheels 3r ride over the rise 112, the vehicle 100 is accelerated to become target vehicle speed Va immediately before the front wheels 3f ride over the rise 112 (S5). The vehicle 100 therefore has necessary and sufficient kinetic energy immediately before riding over the rise 112, and since the front wheels 3f can therefore ride over the rise 112 by inertial force in a single action, effective autonomous driving of the vehicle 100 can be achieved. When contrary to in this embodiment, the front wheels 3f cannot ride over the rise 112 owing to deficient traveling force and/or inertial force of the vehicle 100 when the front wheels 3f are attempting to ride over the rise 112, it becomes necessary to try riding over the rise 112 by once running the vehicle 100 forward and then accelerating it backward to develop momentum for the ride-over. Since this method involves ride-over retries, the ride-over takes time to achieve and smooth parking of the vehicle 100 in the parking space 111 is hard to realize.

The present embodiment can achieve advantages and effects such as the following:

(1) The vehicle control apparatus 50 is configured to control the vehicle 100 so that the front wheels 3f ride over a level difference (rise) 112 between the reference surface 110a and the surface 111a of road after the rear wheels 3r ride over the rise 112. The vehicle control apparatus 50 includes: the ride-over determination unit 51 for determining based on signals from the vehicle speed sensor 32a and/or acceleration sensor 32b whether the rear wheels 3r have ridden over the rise 112, the target vehicle speed calculation unit 52 for calculating target vehicle speed Va for enabling the front wheels 3f to ride over the rise 112 based on, inter alia, change in behavior of the vehicle 100 when ride-over of the rise 112 by the rear wheels 3r is detected by the ride-over determination unit 51, i.e., based on, inter alia, vehicle speeds V0 and V1 immediately before and after ride-over of the rise 112, and driving control unit 46 for controlling traveling behavior of the vehicle 100 after the rear wheels 3r ride over the rise 112, i.e., controlling the actuators AC, so that vehicle speed immediately before the front wheels 3f ride over the rise 112 becomes target vehicle speed Va calculated by the target vehicle speed calculation unit 52 (FIG. 5).

Since vehicle speed immediately before the front wheels 3f ride over the rise 112 is controlled to target vehicle speed Va in this manner, inertial force (kinetic energy) of the vehicle 100 necessary for the front wheels 3f to ride over the rise 112 is obtained and the front wheels 3f can easily ride over the rise 112 by inertial force. Thus, ride-over of road level difference (rise 112) by the front wheels 3f, which is more difficult than ride-over of road level difference by the rear wheels 3r, can be easily achieved by a simple measure of merely increasing vehicle speed to target vehicle speed Va between ride-over of the rise 112 by the rear wheels 3r and ride-over of the rise 112 by the front wheels 3f. This enables low-cost fabrication of the vehicle control apparatus 50 incorporating automatic road level difference (rise 112) ride-over capability, and since it eliminates need to increase vehicle propulsion torque just before ride-over by motoring the engine 1, for example, application not only to hybrid vehicles but also to a wide range of non-hybrid vehicles is also possible.

(2) The vehicle control apparatus 50 includes the vehicle speed sensor 32a for detecting vehicle speed (FIG. 5). Based on the pre-ride-over vehicle speed V0 (first vehicle speed) immediately before the rear wheels 3r ride over the rise 112 and the post-rear-wheel ride-over vehicle speed V1 (second vehicle speed) immediately after the rear wheels 3r ride over the rise 112, which speeds are detected by the vehicle speed sensor 32a, the target vehicle speed calculation unit 52 calculates the target vehicle speed Va (Expression (VI)). Therefore, since target vehicle speed Va required for the front wheels 3f to ride over the rise 112 can be favorably calculated, ride-over of the rise 112 can be accurately performed.

(3) The vehicle control apparatus 50 calculates target vehicle speed Va based on ratio Mf/Mr of front axle vehicle weight Mf applied to the front wheels 3f relative to rear axle vehicle weight Mr applied to the rear wheels 3r (Expression (VI)). Since target vehicle speed Va is, for example, faster in proportion as front wheel axle vehicle weight

Mf is heavier, target vehicle speed Va can therefore be suitably calculated. The reason for this is that although ride-over of the rise 112 by the front wheels 3f is more difficult when front wheel axle vehicle weight Mf is heavy, ride-over can be easily achieved by increasing target vehicle speed Va.

(4) In the vehicle 100, the rear wheels 3r that ride over the rise 112 first are driven wheels and the front wheels 3f are drive wheel. In such a vehicle, ride-over of the rise 112 by the front wheels 3f tends to become difficult after the rear wheels 3r ride over the rise 112, but in the present embodiment ride-over of the rise 112 by the front wheels 3f can be easily achieved by controlling vehicle speed just before the front wheels 3f ride over the rise 112 to target vehicle speed Va.

Various modifications of the aforesaid embodiment are possible. Some examples are explained in the following. In the aforesaid embodiment, the target vehicle speed calculation unit 52 calculates the target vehicle speed Va in accordance with a predefined arithmetic expression (VI) using vehicle speeds V0 and V1 immediately before and after the rear wheels 3r ride over the rise 112 and ratio Mf/Mr of front wheel and rear wheel axle vehicle weights, but a target vehicle speed calculation unit is not limited to this configuration. Target vehicle speed Va for enabling the front wheels 3f to ride over the rise 112 by inertial force can be calculated using other parameters representing change in behavior of the vehicle during ride-over in place of vehicle speeds V0 and V1 before and after ride-over by the rear wheels 3r.

A target vehicle speed calculation unit can be configured to calculate target vehicle speed using a predefined map. Specifically, height of a level difference (rise 112) can be detected by an onboard camera or the like in advance and a map used that sets target vehicle speed faster with increasing height of the level difference. Alternatively, height of the level difference can be calculated from vehicle tilt angle immediately after ride-over of the rear wheels. Alternatively, a map can be used that calculates target vehicle speed to be faster in proportion as total vehicle weight or font axle vehicle weight is heavier. Alternatively, a map can be used that calculates target vehicle speed to be faster in proportion as ratio of font axle vehicle weight to rear axle vehicle weight is greater. Since front wheel ride-over can be expected to be more difficult in proportion as change of vehicle speed just before and just after rear wheel ride-over is greater, target vehicle speed can be calculated to be faster in proportion as change of rear wheel speed is greater. Alternatively, target vehicle speed can be limited using a predefined limit value data of traveling force.

In the aforesaid embodiment, the ride-over determination unit 51 is adapted to determine presence or absence of rear wheel 3r ride-over based on signals from the vehicle speed sensor 32a and acceleration sensor 32b, but a ride over detection unit for detecting that rear wheel (first wheel) has ridden over the level difference is not limited to this configuration. For example, it is possible instead to detect position of the level difference and distance to the level difference using an on-board camera or the like and to detect that rear wheel has ridden over the level difference when the vehicle runs a distance greater than detected distance to the level difference. Also possible is to measure position of the vehicle using a GPS receiver and to detect vehicle ride-over based on the measurement result.

The aforesaid embodiment is explained regarding a case of the wheels 3r and 3f riding over the rise 112 at the entrance of the parking space 111, i.e., a level difference between reference surface 110a of the road (first road surface) and surface 111a of the road (second road surface). However, the present embodiment can be similarly applied to cases of the wheels riding over level differences at locations other than a parking space entrance. Similar application is also possible in a case of the wheels riding over a level difference while running forward rather than in reverse, namely, in a case where the rear wheels ride over the level difference after the front wheels ride over the level difference. The aforesaid embodiment is explained regarding a case in which the surface 111a (second road surface) of the parking space 111 is a horizontal surface, but the road surface following ride-over can instead be, for example, a gradually rising inclined surface.

The aforesaid embodiment is explained regarding a case in which front wheels serving as drive wheels ride over a level difference of the road after rear wheels serving as driven wheels ride over the level difference. Namely, the foregoing explanation is premised on a first wheel being rear wheel and a second wheel being front wheel, but it is possible instead for the first wheel to be front wheel and the second wheel to be rear wheel. Therefore, a first weight applied to the first wheel can be axle vehicle weight applied to the front wheel, and a second weight applied to the second wheel can be axle vehicle weight applied to the rear wheel. Moreover, the present invention can be applied not only to FF-layout vehicles but also similarly to FR-layout and other types of vehicles. The present invention can be applied particularly effectively in a case where a drive wheel rides over a level difference after a driven wheel rides over the level difference.

In the aforesaid embodiment, the vehicle control apparatus 50 is applied to the self-driving vehicle 100, but a vehicle control apparatus of the present invention can be similarly applied to a vehicle having only limited self-driving capabilities, such as a vehicle having only a parking assist apparatus.

The present invention can also be used as a vehicle control method configured to control an actuator for driving a vehicle so that, after a first wheel of one of a front wheel and a rear wheel rides over a level difference between a first road surface and a second road surface higher than the first road surface, a second wheel of the other of the front wheel and the rear wheel rides over the level difference.

The above embodiment can be combined as desired with one or more of the above modifications. The modifications can also be combined with one another.

According to the present invention, since a vehicle speed immediately before ride-over of a level difference is controlled to a target vehicle speed, it is possible to easily apply the present invention to various vehicles.

Above, while the present invention has been described with reference to the preferred embodiments thereof, it will be understood, by those skilled in the art, that various changes and modifications may be made thereto without departing from the scope of the appended claims.

What is claimed is:

1. A vehicle control apparatus configured to control an actuator for driving a vehicle so that, after a first wheel of one of a front wheel and a rear wheel rides over a level difference between a first road surface and a second road surface higher than the first road surface, a second wheel of the other of the front wheel and the rear wheel rides over the level difference,
the vehicle control apparatus comprising:
an electric control unit having a microprocessor and a memory connected to the microprocessor, wherein
the microprocessor is configured to perform:
detecting that the first wheel has ridden over the level difference;
calculating a target vehicle speed required for a riding over of the second wheel when it is detected that the first wheel has ridden over the level difference; and
controlling the actuator so that a vehicle speed immediately before the second wheel rides over the level difference after the first wheel has ridden over the level difference becomes the target vehicle speed.

2. The apparatus according to claim 1, wherein
the microprocessor is configured to perform
the calculating including calculating the target vehicle speed based on a change in behavior of the vehicle when it is detected that the first wheel has ridden over the level difference.

3. The apparatus according to claim 2, further comprising
a vehicle speed detector configured to detect a vehicle speed, wherein
the microprocessor is configured to perform
the calculating including calculating the target vehicle speed based on a first vehicle speed detected by the vehicle speed detector immediately before the first wheel rides over the level difference and a second vehicle speed detected by the vehicle speed detector immediately after the first wheel rides over the level difference.

4. The apparatus according to claim 1, wherein
the calculating including calculating the target vehicle speed based on a ratio of a second weight applied to the second wheel relative to a first weight applied to the first wheel.

5. The apparatus according to claim 1, wherein
the first wheel is a driven wheel and the second wheel is a drive wheel.

6. The apparatus according to claim 1, wherein
the microprocessor is configured to perform
the controlling including controlling the actuator so as to decrease a driving torque to a predetermined value, after controlling the actuator so that the vehicle speed immediately before the second wheel rides over the level difference becomes the target vehicle speed.

7. A vehicle control apparatus configured to control an actuator for driving a vehicle so that, after a first wheel of one of a front wheel and a rear wheel rides over a level difference between a first road surface and a second road surface higher than the first road surface, a second wheel of the other of the front wheel and the rear wheel rides over the level difference,
the vehicle control apparatus comprising:
an electric control unit having a microprocessor and a memory connected to the microprocessor, wherein
the microprocessor is configured to function as:
a ride over detection unit configured to detect that the first wheel has ridden over the level difference; a target vehicle speed calculation unit configured to calculate a target vehicle speed required for a riding over of the second wheel when it is detected by the ride over detection unit that the first wheel has ridden over the level difference; and
a drive control unit configured to control the actuator so that a vehicle speed immediately before the second wheel rides over the level difference after the first wheel has ridden over the level difference becomes the target vehicle speed.

8. The apparatus according to claim 7, wherein
the target vehicle speed calculation unit is configured to calculate the target vehicle speed based on a change in behavior of the vehicle when it is detected by the ride over detection unit that the first wheel has ridden over the level difference.

9. The apparatus according to claim 8, further comprising
a vehicle speed detector configured to detect a vehicle speed, wherein
the target vehicle speed calculation unit is configured to calculate the target vehicle speed based on a first vehicle speed detected by the vehicle speed detector immediately before the first wheel rides over the level difference and a second vehicle speed detected by the vehicle speed detector immediately after the first wheel rides over the level difference.

10. The apparatus according to claim 7, wherein
the target vehicle speed calculation unit is configured to calculate the target vehicle speed based on a ratio of a second weight applied to the second wheel relative to a first weight applied to the first wheel.

11. The apparatus according to claim 7, wherein
the first wheel is a driven wheel and the second wheel is a drive wheel.

12. The apparatus according to claim 7, wherein
the drive control unit is configured to control the actuator so as to decrease a driving torque to a predetermined value, after controlling the actuator so that the vehicle speed immediately before the second wheel rides over the level difference becomes the target vehicle speed.

13. A vehicle control method configured to control an actuator for driving a vehicle so that, after a first wheel of one of a front wheel and a rear wheel rides over a level difference between a first road surface and a second road surface higher than the first road surface, a second wheel of the other of the front wheel and the rear wheel rides over the level difference,
the vehicle control method comprising:
detecting that the first wheel has ridden over the level difference;
calculating a target vehicle speed required for a riding over of the second wheel when it is detected in the detecting that the first wheel has ridden over the level difference; and
controlling the actuator so that a vehicle speed immediately before the second wheel rides over the level difference after the first wheel has ridden over the level difference becomes the target vehicle speed.

14. The method according to claim 13, wherein
the calculating includes calculating the target vehicle speed based on a change in behavior of the vehicle when it is detected in the detecting that the first wheel has ridden over the level difference.

15. The method according to claim 14, further comprising
detecting a vehicle speed, wherein
the calculating includes calculating the target vehicle speed based on a first vehicle speed detected in the detecting immediately before the first wheel rides over the level difference and a second vehicle speed detected in the detecting immediately after the first wheel rides over the level difference.

16. The method according to claim 13, wherein
the calculating includes calculating the target vehicle speed based on a ratio of a second weight applied to the second wheel relative to a first weight applied to the first wheel.

17. The method according to claim 13, wherein
the first wheel is a driven wheel and the second wheel is a drive wheel.

18. The method according to claim 13, wherein
the controlling includes controlling the actuator so as to decrease a driving torque to a predetermined value, after controlling the actuator so that the vehicle speed immediately before the second wheel rides over the level difference becomes the target vehicle speed.
